(19) United States
(12) Patent Application Publication
(10) Pub. No.: US 2009/0189774 A1
(43) Pub. Date: Jul. 30, 2009

(54) Power Topology Determination

(75) Inventors: Michael Brundridge, Georgetown, TX (US); Anil Venkatasubba Rao, Cedar Park, TX (US); Sudhir Shetty, Cedar Park, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/020,636

(22) Filed: Jan. 28, 2008

(51) Int. Cl. G08B 21/00

(52) U.S. Cl. 340/654

(57) ABSTRACT

A power topology determination system includes a management engine. A power line communication device is coupled to the management engine. A first power device is coupled to the power line communication device through a power line connection. The power line communication device is operable to retrieve first power device information from the first power device and the management engine is operable to provide the first power device information for power topology display.

### BACKGROUND

The present disclosure relates generally to information handling systems, and more particularly to determining information handling system power topology.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Power topology describes the interconnect between power devices such as, for example, power supply units (PSUs), uninterruptible power supplies (UPSs), power distribution units (PDUs), and/or a variety of other power devices known in the art. The determination of power topology as it relates to an IHS or groups of IHSs can raise a number of issues.

Enabling an IHS administrator to determine power topology enables the administrator to, for example, plan for extra IHS capacity, make connectivity decisions, and determine power infrastructure. Typically, IHS administrators will capture the power topology in a spreadsheet, which is manually compiled and must be manually updated as changes are made to the system. Capacity planning consoles are available that also require manual compilation, configuration, and setup to capture this information. Such conventional techniques are error-prone and can lead to incorrect power planning decisions.

Accordingly, it would be desirable to provide for improved power topology determination.

### SUMMARY

According to one embodiment, a power topology determination system includes a management engine, a power line communication device coupled to the management engine, and a first power device coupled to the power line communication device through a power line, wherein the power line communication device is operable to retrieve first power device information from the first power device and the management engine is operable to provide the first power device information for power topology display.

### BRIEF DESCRIPTION OF THE DRAWINGS

FIG. 1 is a schematic view illustrating an embodiment of an IHS.

FIG. 2a is a schematic view illustrating an embodiment of a power topology determination system.

FIG. 2b is a schematic view illustrating an embodiment of an IHS used with the power topology determination system of FIG. 2a.

FIG. 2c is a schematic view illustrating an embodiment of PSU used with the IHS of FIG. 2b.

FIG. 3a is a flow chart illustrating an embodiment of a method for power topology determination.

FIG. 3b is a display view illustrating an embodiment of a power topology of the system of FIG. 2a.

FIG. 4a is a schematic view illustrating an embodiment of a power topology determination system.

FIG. 4b is a schematic view illustrating an embodiment of an IHS used with the power topology determination of FIG. 4a.

FIG. 4c is a display view illustrating an embodiment of a power topology of the system of FIG. 4a.

FIG. 5a is a schematic view illustrating an embodiment of a power topology determination system.

FIG. 5b is a display view illustrating an embodiment of a power topology of the system of FIG. 5a.

FIG. 6a is a schematic view illustrating an embodiment of a power topology determination system.

FIG. 6b is a display view illustrating an embodiment of a power topology of the system of FIG. 6a.

FIG. 7a is a schematic view illustrating an embodiment of a power topology determination system.

FIG. 7b is a display view illustrating an embodiment of a power topology of the system of FIG. 7a.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

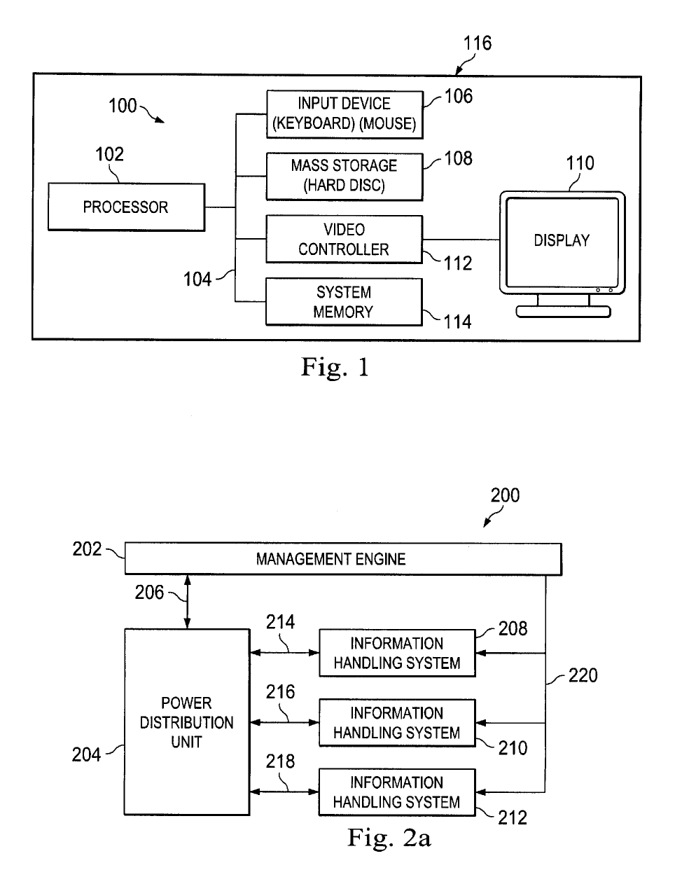

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

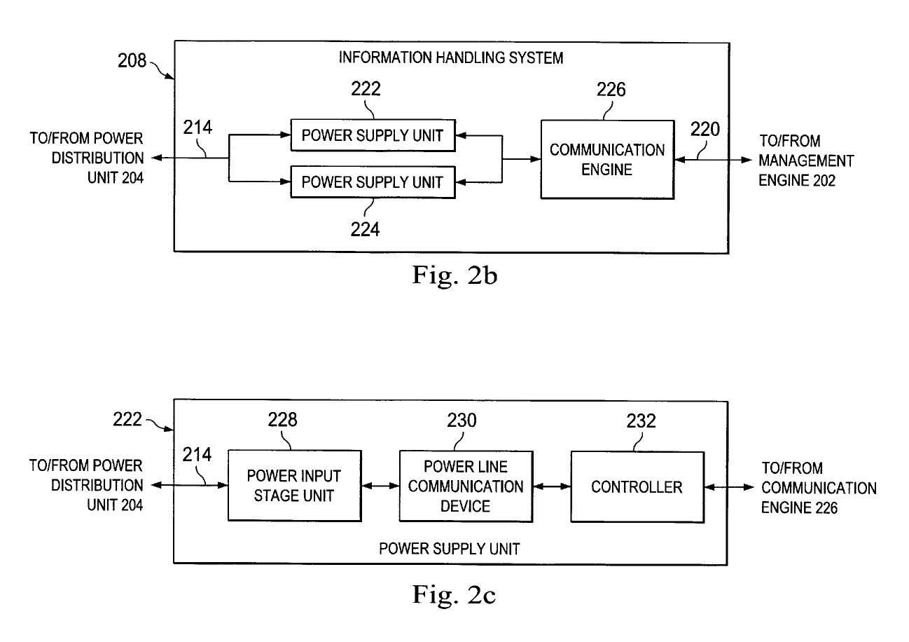

Referring now to FIG. 2a, a power topology determination system 200 is illustrated. Some of the power topologies described below are directed to IHS power topologies. However, the present disclosure is not so limited, and the power topology determination system may be applied to any system that includes devices that use power. The power topology determination system 200 includes a management engine 202. The management engine 202 may be, for example, software stored on a computer-readable medium located in a management IHS that may be the IHS 100, described above with reference to FIG. 1. The management engine 202 is coupled to a PDU 204 through a connection 206. In an embodiment, the PDU 204 is operable to receive power from a power source and provide that power to a plurality of devices. In an embodiment, the PDU 204 includes a power line communication device that is operable to enable and/or assist the transmission and/or reception of information over a conventional power line that transmits power such as, for example, AC and/or DC power. In an embodiment, the PDU 204 includes a bridge that allows a power line communication signal to be transmitted and/or amplified through the PDU 204. In an embodiment, the PDU 204 is coupled to an outside power source (not shown). In an embodiment, the connection 206 is a management bus connection such as, for example, a Broadband over Power Line (BPL) connection, an Ethernet connection, an RS232 connection, an RS485 connection, and/or a variety of other connections known in the art that are operable to transfer information between the PDU 204 and the management engine 202. The PDU 204 is coupled to a plurality of IHSs 208, 210 and 212 through a plurality of connections 214, 216 and 218, respectively. In an embodiment, the IHSs 208, 210 and 212 may each be the IHS 100, described above with reference to FIG. 1. In an embodiment, the connections 214, 216 and 218 are power line connections known in the art that are operable to provide power such as, for example, alternating current (AC) power and/or direct current (DC) power, from the PDU 204 to the IHSs 208, 210 and 212. While the IHSs 208, 210 and 212 are illustrated as each being coupled to the PDU 204 though a separate connection 214, 216 and 218, respectively, the IHSs 208, 210 and/or 212 may share a connection. The management engine 202 may also be coupled to the IHSs 208, 210 and 212 through a connection 220. In an embodiment, the connection 220 is a management bus connection such as, for example, a BPL connection, an Ethernet connection, an RS232 connection, an RS485 connection, and/or a variety of other connections known in the art that are operable to transfer information between the IHSs 208, 210 and 212 and the management engine 202. In an embodiment, the connections 206, 214, 216, 218 and 220 allow communication between the management engine 202, the PDU 204, and the IHSs 208, 210 and 212 for gathering information that helps associate the PDU 204 and the IHSs 208, 210 and 212 and show the topological relationships between the power infrastructure components of the system 200.

Referring now to FIG. 2b, the IHS 208 is illustrated in more detail. In an embodiment, the IHSs 210 and 212 may be substantially similar to the IHS 208. The IHS 208 includes a pair of PSUs 222 and 224 that are coupled to the PDU 204 through the connection 214. In an embodiment, the PSUs 222 and 224 are operable to convert AC and/or DC power from the PDU 204 such that it may be used by the IHS 208. A communication engine 226 is coupled to the PSUs 222 and 224. The communication engine 226 is also coupled to the management engine 202 through the connection 220. In an embodiment, the communication engine 226 may be, for example, software stored on a computer-readable medium located in the IHS 208 and operable to assist or enable communication through a management bus connection and/or a variety of other connections known in the art. In an embodiment, the PDU 204 and the PSUs 222 and 224 may be referred to as power devices.

Referring now to FIG. 2c, the PSU 222 is illustrated in more detail. In an embodiment, the PSU 224 may be substantially similar to the PSU 222. The PSU 222 includes a power input stage unit 228 that is coupled to the PDU 204 through the connection 214. In an embodiment, the power input stage unit 228 is operable to convert, rectify, step up, step down, and/or perform a variety of other actions to power that enters the PSU 222 through the connection 214. A power line communication device 230 is coupled to the power input stage unit 228. In an embodiment, the power line communication device 230 is operable to enable and/or assist the transmission of information over a conventional power line that transmits power such as, for example, AC and/or DC power. A controller 232 is coupled to the power line communication device 230 and the communication engine 226. In an embodiment, the controller 232 is responsible for management of the PSU 222.

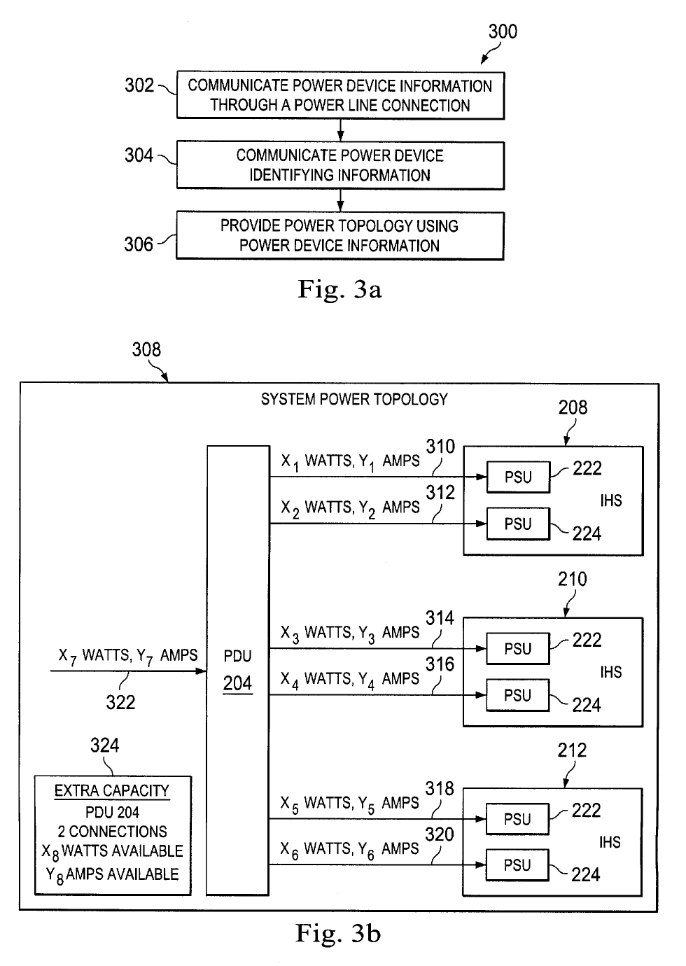

Referring now to FIGS. 2a, 2b, 2c, 3a and 3b, a method 300 for power topology determination is illustrated. The method 300 begins at block 302 where power device information is communicated through a power line connection. In an embodiment, the PSUs (e.g. PSUs 222 and 224) in the IHSs 208, 210 and 212 communicate with the PDU 204 over the connections 214, 216 and 218, respectively, using the power line communication device 230 to transmit power device information from the PSUs to the PDU 214. In an embodiment, the power device information includes PSU field replaceable unit (FRU) information, power consumption information, and/or a variety of other power device information known in the art. The PDU 204 will store the power device information and dynamically update it as the connectivity changes. In an embodiment, removal of the power link between a PSU and the PDU 204 will result in the power device information for that PSU being removed from the PDU 204. The method 300 then proceeds to block 304 where power device identifying information is communicated. The management engine 202 communicates with the IHSs 208, 210 and 212 through the connection 220 to determine power device identifying information such as, for example, FRU information from each of the PSUs (e.g., the PSUs 222 and 224) located in the IHSs 208, 210 and 212.

The method 300 then proceeds to block 306 where a power topology is provided using the power device information. In an embodiment, the management engine 202 may communicate with the PDU 204 to access the power device information communicated from the PSUs to the PDU 204 in block 302 of the method 300, and may then correlate that power device information with the power device identifying information communicated in block 304 of the method 300 to define a link between each of the PSUs and the PDU 204. The management engine 202 may then use all of the information communicated to create a power topology display that illustrates the PDU 204, the IHSs 208, 210 and 212, the PSUs 222 and 224, and the connections between them. For example, a power topology display 308, illustrated in FIG. 3b, illustrates the PDU 204 and the IHSs 208, 210 and 212 each including PSUs 222 and 224. In an embodiment, the power topology 308 may be displayed on a display (e.g., the display 110 described above with reference to FIG. 1), on a print out, and/or using a variety of other display methods known in the art. A plurality of connections 310 and 312 represent the connections between the PDU 204 and the PSUs 222 and 224, respectively, in the IHS 208. In the illustrated embodiment, the connections 310 and 312 include an indication of power consumption information such as, for example, how many volts, watts, and/or amps of power are being drawn by the IHS 208 PSUs 222 and 224, respectively, from the PDU 204. A plurality of connections 314 and 316 represent the connections between the PDU 204 and the PSUs 222 and 224, respectively, in the IHS 210. In the illustrated embodiment, the connections 314 and 316 include an indication of power consumption information such as, for example, how many volts, watts, and/or amps of power are being drawn by the IHS 210 PSUs 222 and 224, respectively, from the PDU 204. A plurality of connections 318 and 320 represent the connections between the PDU 204 and the PSUs 222 and 224, respectively, in the IHS 212. In the illustrated embodiment, the connections 310 and 312 include an indication of power consumption information such as, for example, how many volts, watts, and/or amps of power are being drawn by the IHS 212 PSUs 222 and 224, respectively, from the PDU 204. A connection 322 represents the connection between the PDU 204 and, for example, an outside power source such a conventional AC or DC power source. In the illustrated embodiment, the connection 322 includes an indication of power consumption information such as, for example, how many volts, watts, and/or amps of power are being drawn by the PDU 204 from the outside power source. In an embodiment, the management engine 202 may determine from the information collected in blocks 302 and 304 of the method 300 that extra power capacity exists and may provide an indicator 324 on the power topology 308 that such extra power capacity exists, for example, in the PDU 204.

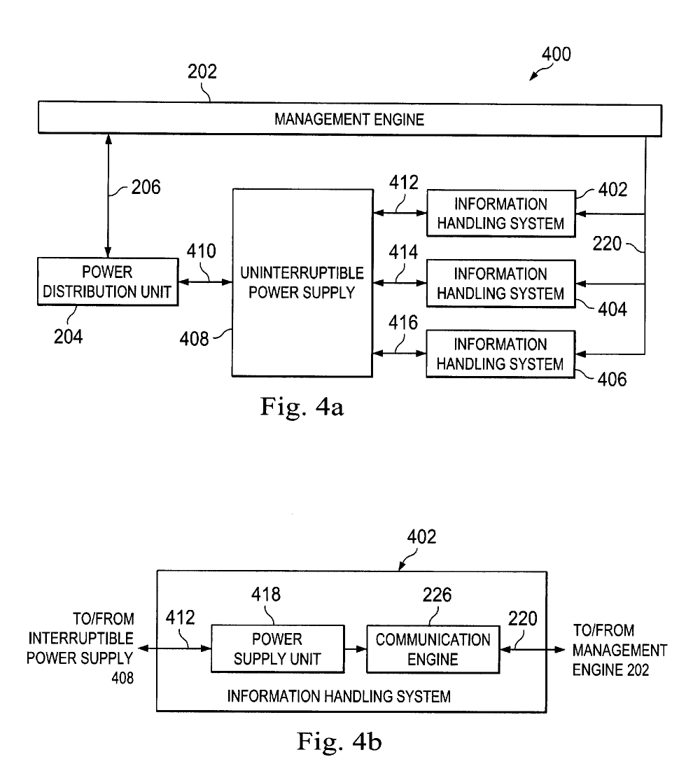

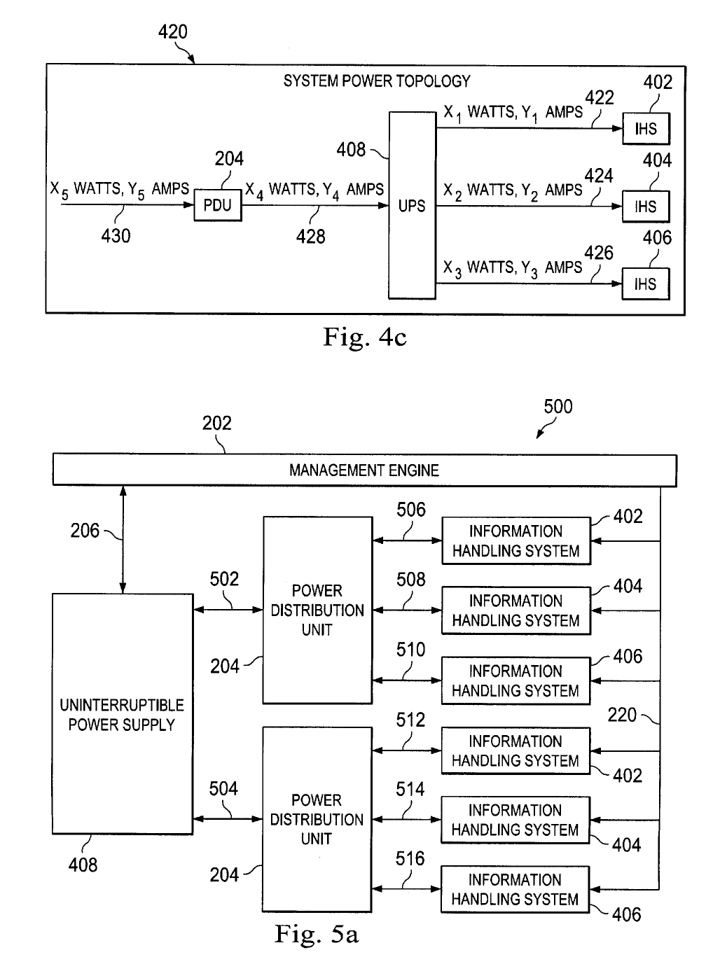

Referring now to FIG. 4a, a power topology determination system 400 is illustrated that is substantially similar to the power topology system 200, described above with reference to FIG. 2a, with the provision of a plurality of IHSs 402, 404 and 406 replacing the IHSs 208, 210 and 212 and an uninterruptible power supply 408 coupled to and located between the PDU 204 and the IHSs 402, 404 and 406. The PDU 204 is coupled to the uninterruptible power supply 408 through a connection 410, respectively. In an embodiment, the uninterruptible power supply 408 is a device that supplies power and includes a backup power source such as, for example, batteries and/or a fueled generator, such that power from the uninterruptible power supply 408 will not be interrupted if its primary power delivery method is stopped. In an embodiment, the uninterruptible power supply 408 includes a power line communication device that is operable to enable and/or assist the transmission and/or reception of information over a conventional power line that transmits power such as, for example, AC and/or DC power. In an embodiment, the uninterruptible power supply 408 includes a bridge that allows a power line communication signal to be transmitted and/or amplified through the uninterruptible power supply 408. In an embodiment, the connection 410 is a power line connection known in the art that provides power such as, for example, AC and/or DC power, from the PDU 204 to the uninterruptible power supply 408. The uninterruptible power supply 408 is coupled to the IHSs 402, 404 and 406 through a plurality of connections 412, 414 and 416, respectively. In an embodiment, the IHSs 402, 404 and 406 may each be the IHS 100, described above with reference to FIG. 1. In an embodiment, the connections 412, 414 and 416 are power line connections known in the art that are operable to provide power such as, for example, AC and/or DC power, from the uninterruptible power supply 408 to the IHSs 402, 404 and 406. While the IHSs 402, 404 and 406 are illustrated as each being coupled to the uninterruptible power supply 408 though a separate connection 412, 414 and 416, respectively, the IHSs 402, 404 and/or 406 may share a connection. In an embodiment, the management engine 202 may be coupled to the uninterruptible power supply 408 through a management bus connection (not shown) such as, for example, a BPL connection, an Ethernet connection, an RS232 connection, an RS485 connection, and/or a variety of other connections known in the art that are operable to transfer information between management engine 202 and the uninterruptible power supply 408. In an embodiment, the connections 206, 220, 410, 412, 414 and 416 allow communication between the management engine 202, the PDU 204, the UPS 408, and the IHSs 402, 404 and 406 for gathering information that helps associate the PDU 204, the UPS 408, and the IHSs 402, 404 and 406 and show the topological relationships between the power infrastructure components of the system 400.

Referring now to FIG. 4b, the IHS 402 is illustrated in more detail. In an embodiment, the IHSs 404 and 406 may be substantially similar to the IHS 402. The IHS 402 is substantially similar to the IHS 208, described above with reference to FIG. 2b, with the provision of a single PSU 418 replacing the pair of PSUs 222 and 224. The PSU 418 is coupled to the uninterruptible power supply 408 through the connection 412. In an embodiment, the PSU 418 is operable to convert AC and/or DC power from the uninterruptible power supply 408 such that it may be used by the IHS 402. In an embodiment, the uninterruptible power supply 408 and the PSU 418 may be referred to as power devices.

Referring now to FIGS. 3a, 4a, 4b and 4c, the method 300 for power topology determination may be applied to the power topology system 400. The method 300 begins at block 302 where power device information is communicated through a power line connection. In an embodiment, the uninterruptible power supply 408 and the PSUs (e.g. the PSU 418) in the IHSs 402, 404 and 406 communicate with the PDU 204 to transmit power device information from the PSUs and the uninterruptible power supply 408 to the PDU 204 through the connections 410, 412, 414 and 416. In an embodiment, the power device information includes PSU FRU information, uninterruptible power supply FRU information, power consumption information, and/or a variety of other power device information known in the art. The PDU 204 will store the power device information and dynamically update it as the connectivity changes. In an embodiment, removal of the power link between a PSU or the UPS 408 and the PDU 204 will result in the power device information for that PSU or UPS 408 being removed from the PDU 204. The method 300 then proceeds to block 304 where power device identifying information is communicated. The management engine 202 communicates with the IHSs 402, 404 and 406 through the connection 220 to determine power device identifying information such as, for example, FRU information from each of the PSUs (e.g., the PSU 418) located in the IHSs 402, 404 and 406. In an embodiment, the uninterruptible power supply 408 may be connected to the management engine 202 through, for example, a management bus connection (not shown) such as, for example, a BPL connection, an Ethernet connection, an RS232 connection, an RS485 connection, and/or a variety of other connections known in the art that are operable to allow communication between the uninterruptible power supply 408 and the management engine 202. In an embodiment, the PDU 204 and/or the UPS 408 may include a bridge that allows a power line communication signal to be transferred or amplified through the PDU 204 and/or the UPS 408 in order to allow the transfer of topology information through the PDU 204 and/or the UPS 408 from power devices that are connected to them.

The method 300 then proceeds to block 306 where a power topology is provided using the power device information. In an embodiment, the management engine 202 may communicate with the PDU 204 to access the power device information communicated from the uninterruptible power supply 408 and the PSUs in the IHSs 402, 404 and 406 to the PDU 204 in block 302 of the method 300, and may then correlate that power device information with the power device identifying information communicated in block 304 of the method 300 to define a link between the uninterruptible power supply 408, each of the PSUs in the IHSs 402, 404 and 406, and the PDU 204. In an embodiment, the management engine 202 may communicate with both the PDU 204 and the uninterruptible power supply 408 in order to get connectivity information for each power device. The management engine 202 may then use all of the information communicated to create a power topology display that illustrates the PDU 204, the uninterruptible power supply 408, the IHSs 402, 404 and 406 each with a PSU 418, and the connections between them. For example, a power topology display 420, illustrated in FIG. 4c, illustrates the IHSs 402, 404 and 406 (with no separate indication of the PSUs due to, for example, each IHS including only one PSU), the uninterruptible power supply 408, and the PDU 204. In an embodiment, the power topology 420 may be displayed on a display (e.g., the display 110 described above with reference to FIG. 1), on a print out, and/or using a variety of other display methods known in the art. A plurality of connections 422, 424 and 426 represent the connections between the uninterruptible power supply 408 and the IHSs 402, 404 and 406. In the illustrated embodiment, each of the connections 422, 424 and 426 include an indication of power consumption information such as, for example, how many volts, watts, and/or amps of power are being drawn by the IHSs 402, 404 and 406 PSUs from the UPS 408. A connection 428 represents the connection between the PDU 204 and the uninterruptible power supply 408. In the illustrated embodiment, the connection 428 includes an indication of power consumption information such as, for example, how many volts, watts, and/or amps of power are being drawn by the uninterruptible power supply 408 from the PDU 204. A connection 430 represents the connection between the PDU 204 and, for example, an outside power source such a conventional AC and/or DC power source. The connection 430 includes an indication of power consumption information such as, for example, how many volts, watts, and/or amps of power are being drawn by the PDU 204 from the outside power source.

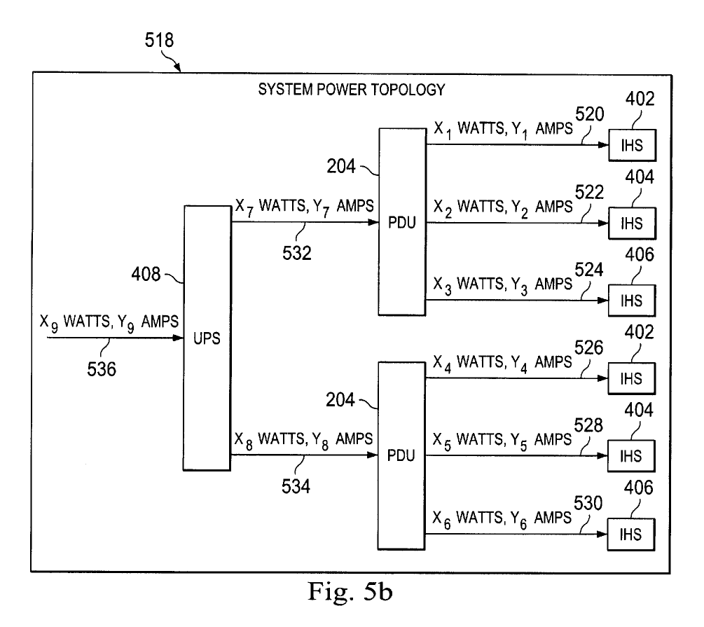

Referring now to FIG. 5a, a power topology determination system 500 is illustrated that is substantially similar to the power topology system 400, described above with reference to FIG. 4a, with the provision of an additional PDU 204, additional IHSs 402, 404 and 406, and a rearrangement of the components. The management engine 202 is coupled to the uninterruptible power supply 408 through the connection 206. A pair of PDUs 204 are coupled to the uninterruptible power supply 408 through a plurality of connections 502 and 504. In an embodiment, the connections 502 and 504 are power line connections known in the art that are operable to provide power such as, for example, AC and/or DC power, from the uninterruptible power supply 408 to the PDUs 204. In an embodiment, the PDUs 204 are coupled to the management engine 202 through a management bus connection (not shown) such as, for example, a BPL connection, an Ethernet connection, an RS232 connection, an RS485 connection, and/or a variety of other connections known in the art that are operable to transfer information between the PDUs 204 and the management engine 202. One of the PDU 204 is coupled to a plurality of the IHSs 402, 404 and 406 through a plurality of connections 506, 508, 510, respectively, and the other PDU 204 is coupled to a plurality of the IHSs 402, 404 and 406 though a plurality of connections 512, 514 and 516, respectively. In an embodiment, the connections 506, 508, 510, 512, 514 and 516 are power line connections known in the art that are operable to provide power such as, for example, AC and/or DC power, from the PDUs 204 to the IHSs 402, 404 and 406. While the IHSs 402, 404 and 406 are illustrated as each being coupled to their PDUs 204 though a separate connection, the IHSs 402, 404 and/or 406 may share a connection. The management engine 202 is also coupled to the IHSs 402, 404 and 406 through the connection 220. In an embodiment, the connection 220 is a management bus connection such as, for example, a BPL connection, an Ethernet connection, an RS 232 connection, an RS 485 connection, and/or a variety of other connections known in the art that are operable to transfer information between the IHSs 402, 404 and 406 and the management engine 202. In an embodiment, the connections 206, 220, 502, 504, 506, 508, 510, 512, 514 and 516 allow communication between the management engine 202, the UPS 408, the PDUs 204, and the IHSs 402, 404 and 406 for gathering information that helps associate the UPS 408, the PDUs 204, and the IHSs 402, 404 and 406 and show the topological relationships between the power infrastructure components of the system 500.

Referring now to FIGS. 3a, 5a and 5b, the method 300 for power topology determination may be applied to the power topology system 500. The method 300 begins at block 302 where power device information is communicated through a power line connection. In an embodiment, the PDUs 204 and the PSUs (e.g. the PSU 418) in the IHSs 402, 404 and 406 communicate with the uninterruptible power supply 408 to transmit power device information from the PDUs 204 and the PSUs in the IHSs 402, 404 and 406 to the uninterruptible power supply 408 through the connections 502, 504, 506, 508, 510, 512, 514 and 516. In an embodiment, the power device information includes PSU FRU information, PDU FRU information, power consumption information, information used to associate the PSUs in the IHSs with information communicated via the connection 220, and/or a variety of other power device information known in the art. The uninterruptible power supply 408 will store the power device information and dynamically update it as the connectivity changes. In an embodiment, removal of the power link between a uninterruptible power supply 408 and the PDUs 204 or the IHSs 402, 404 and/or 406 will result in the power device information for that PDU or IHS being removed from the uninterruptible power supply 408. The method 300 then proceeds to block 304 where power device identifying information is communicated. The management engine 202 communicates with the IHSs 402, 404 and 406 through the connection 220 to determine power device identifying information such as, for example, FRU information from each of the PSUs (e.g., the PSU 418) located in the IHSs 402, 404 and 406. In an embodiment, the management engine 202 may communicate with the PDUs 204 through, for example, a management bus connection (not shown) such as, for example, a BPL connection, an Ethernet connection, an RS232 connection, an RS485 connection, and/or a variety of other connections known in the art that are operable to allow communication between the PDUs 204 and the management engine 202.

The method 300 then proceeds to block 306 where a power topology is provided using the power device information. In an embodiment, the management engine 202 may communicate with the uninterruptible power supply 408 to access the power device information communicated from PDUs 204 and the PSUs in the IHSs 402, 404 and 406 to the uninterruptible power supply 408 in block 302 of the method 300, and may then correlate that power device information with the power device identifying information communicated in block 304 of the method 300 to define a link between PDUs 204, each of the PSUs in the IHSs 402, 404 and 406, and the uninterruptible power supply 408. In an embodiment, the management engine 202 may communicate with both of the uninterruptible power supply 408 and the PDUs 204 to determine what power devices are connected to the system. The management engine 202 may then use all of the information communicated to create a power topology display that illustrates the PDUs 204, the uninterruptible power supply 408, the IHSs 402, 404 and 406 each with a PSU 418, and the connections between them. For example, a power topology display 518, illustrated in FIG. 5b, illustrates the IHSs 402, 404 and 406 (with no separate indication of the PSUs due to, for example, each IHSs including only one PSU), their respective PDUs 204, and the uninterruptible power supply 408. In an embodiment, the power topology 518 may be displayed on a display (e.g., the display 110 described above with reference to FIG. 1), on a print out, and/or using a variety of other display methods known in the art. A plurality of connections 520, 522, 524, 526, 528 and 530 represent the connections between the PDUs 204 and the IHSs 402, 404 and 406. In the illustrated embodiment, each of the connections 520, 522, 524, 526, 528 and 530 include an indication of power consumption information such as, for example, how many volts, watts, and/or amps of power are being drawn by the IHSs 402, 404 and 406 PSUs from their respective PDUs 204. A plurality of connections 532 and 534 represent the connections between the PDUs 214 and the uninterruptible power supply 408. In the illustrated embodiment, the connections 532 and 534 include an indication of power consumption information such as, for example, how many volts, watts, and/or amps of power are being drawn by the PDUs 204 from the uninterruptible power supply 408. A connection 536 represents the connection between the uninterruptible power supply 408 and, for example, an outside power source such a conventional AC and/or DC power source. The connection 536 includes an indication of power consumption information such as, for example, how many volts, watts, and/or amps of power are being drawn by the uninterruptible power supply 408 from the outside power source.

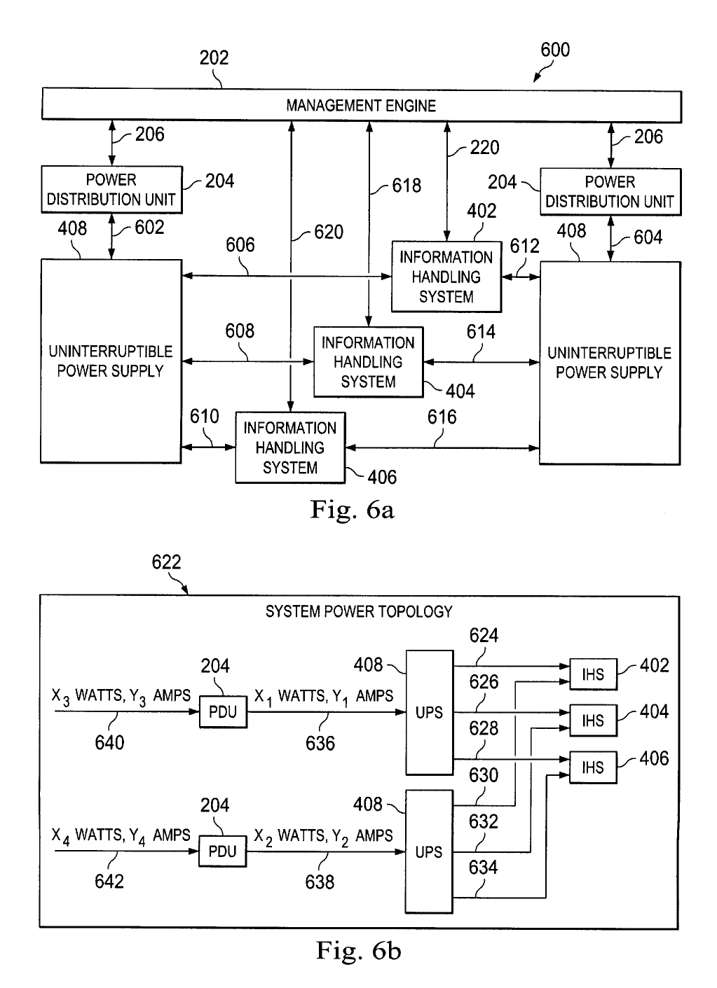

Referring now to FIG. 6a, a power topology determination system 600 is illustrated that is substantially similar to the power topology system 400, described above with reference to FIG. 4a, with the provision of an additional PDU 204, an additional uninterruptible power supply 408, and a rearrangement of the components. The management engine 202 is coupled to each of the PDUs 204 through the connection 206. Each of the PDUs 204 is coupled to a respective uninterruptible power supply 408 through a connections 602 and 604, respectively. In an embodiment, the connections 602 and 604 are power line connections known in the art that are operable to provide power such as, for example, AC and/or DC power, from the PDUs 204 to the UPSs 408. In an embodiment, the management engine 202 is connected to the uninterruptible powers supplies 408 through a management bus connection (not shown) such as, for example, a BPL connection, an Ethernet connection, an RS232 connection, an RS485 connection, and/or a variety of other connections known in the art that are operable to transfer information between the management engine 202 and the uninterruptible powers supplies 408. Each of the UPSs 408 is coupled to the same plurality of IHSs 402, 404 and 406 through a plurality of connections 606, 608, 610, 612, 614 and 616, respectively, to provide a redundant power supply to each IHS 402, 404 and 406. In an embodiment, the IHSs 402, 404 and 406 may each be the IHS 100, described above with reference to FIG. 1. In an embodiment, the connections 606, 608, 610, 612, 614 and 616 are power line connections known in the art that are operable to provide power such as, for example, AC and/or DC power, from the UPSs 408 to the IHSs 402, 404 and 406. While the IHSs 402, 404 and 406 are illustrated as each being coupled to each of the PDUs 204 though a separate connection, the IHSs 402, 404 and/or 406 may share a connection. The management engine 202 is coupled to the IHSs 402, 404 and 406 though a plurality of connections 220, 618 and 620. In an embodiment, the connections 220, 618 and 620 are management bus connections such as, for example, a BPL connection, an Ethernet connection, an RS232 connection, an RS485 connection, and/or a variety of other connections known in the art that are operable to transfer information between the IHSs 402, 404 and 406 and the management engine 202.

Referring now to FIGS. 3a, 6a and 6b, the method 300 for power topology determination may be applied to the power topology system 600. The method 300 begins at block 302 where power device information is communicated through a power line connection. In an embodiment, the UPSs 408 and the PSUs (e.g. the PSU 418) in the IHSs 402, 404 and 406 communicate with the PDUs 204 to transmit power device information from the UPSs 408 and the PSUs in the IHSs 402, 404 and 406 to the PDUs 204 through the connections 602, 604, 606, 608, 610, 612, 614 and 616. In an embodiment, the power device information includes uninterruptible power supply FRU information, PSU FRU information, power consumption information, and/or a variety of other power device information known in the art. The PDUs 204 will store the power device information and dynamically update it as the connectivity changes. In an embodiment, removal of a power link between the PDUs 204, the UPSs 408, and the IHSs 402, 404 and 406 will result in the power device information for that UPS and/or IHS being removed from the PDUs 204. The method 300 then proceeds to block 304 where power device identifying information is communicated. The management engine 202 communicates with the IHSs 402, 404 and 406 through the connections 220, 618 and 620 to determine power device identifying information such as, for example, FRU information from each of the PSUs (e.g., the PSU 418) located in the IHSs 402, 404 and 406. In an embodiment, the management engine 202 may also communicate with the UPSs 408 through, for example, a management bus connection (not shown) such as, for example, a BPL connection, an Ethernet connection, an RS 232 connection, an RS 485 connection, and/or a variety of other connections known in the art that are operable to allow communication between the UPSs 408 and the management engine 202.

The method 300 then proceeds to block 306 where a power topology is provided using the power device information. In an embodiment, the management engine 202 may communicate with the PDUs 204 to access the power device information communicated from UPSs 408 and the PSUs in the IHSs 402, 404 and 406 to the PDUs 204 in block 302 of the method 300, and may then correlate that power device information with the power device identifying information communicated in block 304 of the method 300 to define a link between power distributions units 204, the UPSs 408, and the PSUs in the IHSs 402, 404 and 406. The management engine 202 may then use all of the information communicated to create a power topology display that illustrates the PDUs 204, the uninterruptible power supply 408, the IHSs 402, 404 and 406 each with a PSU 418, and the connections between them. For example, a power topology display 622, illustrated in FIG. 6b, illustrates the IHSs 402, 404 and 406 (with no separate indication of the PSUs due to, for example, each IHS including only one PSU), the UPSs 408, and the PDUs 204. In an embodiment, the power topology 622 may be displayed on a display (e.g., the display 110 described above with reference to FIG. 1), on a print out, and/or using a variety of other display methods known in the art. A plurality of connections 624, 626, 628, 630, 632 and 634 represent the redundant power connections between the UPSs 408 and the IHSs 402, 404 and 406. In an embodiment, the management engine 202 may communicate with both the PDUs 204 and the UPSs 408 to access the power device information. In the illustrated embodiment, each of the connections 624, 626, 628, 630, 632 and 634 may include an indication of power consumption information (not shown for clarity) such as, for example, how many volts, watts, and/or amps of power are being drawn by the IHSs 402, 404 and 406 PSUs from their respective UPSs 408. A plurality of connections 636 and 638 represent the connections between the UPSs 408 and their respective PDUs 214. In the illustrated embodiment, the connections 636 and 638 include an indication of power consumption information such as, for example, how many volts, watts, and/or amps of power are being drawn by the UPSs 408 from their respective PDUs 204. Connections 640 and 642 represent the connections between the PDUs 204 and, for example, an outside power source such a conventional AC and/or DC power source. The connections 640 and 642 include an indication of power consumption information such as, for example, how many volts, watts, and/or amps of power are being drawn by the PDUs 204 from the outside power source.

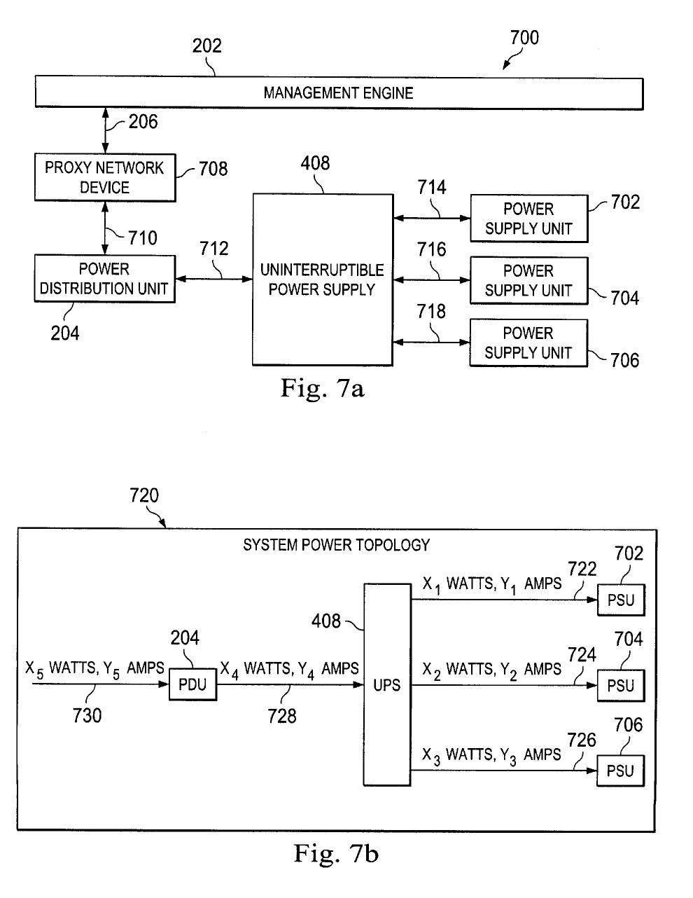

Referring now to FIG. 7a, a power topology determination system 700 is illustrated that is substantially similar to the power topology system 400, described above with reference to FIG. 4a, with the provision of a plurality of PSUs 702, 704 and 706 replacing the IHSs 402, 404 and 408, and a proxy network device 708 coupled between the PDU 204 and the management engine 202. The management engine 202 is coupled to the proxy network device 708 through the connection 206. In an embodiment, the proxy network device 708 may be located anywhere between an outside power source (e.g., a site transformer) and the system for which a power topology display is desired. In an embodiment, the proxy network device 708 may be integrated with the PDU 204. In an embodiment, the proxy network device 708 may be integrated with the management engine 202, negating the need for the connection 206. In an embodiment, the proxy network device 708 includes a power line communication device that allows the proxy network device 708 to communicate with another device through a power line. In an embodiment, the proxy network device 708 is operable to convert one wire protocol to another wire protocol. For example, the proxy network device 708 may convert a power line communication data signal to another communication format signal such as a BPL signal, an Ethernet signal, an RS232 signal, an RS485 signal, and/or a variety of other communication signals known in the art. A PDU 204 is coupled to the proxy network device 708 through a connection 710. In an embodiment, the connection 710 is a power line connection known in the art that is operable to provide power such as, for example, AC and/or DC power, to the PDU 204. The PDU 204 is coupled to the uninterruptible power supply 408 through a connection 712. In an embodiment, the connection 712 is a power line connection known in the art that is operable to provide power such as, for example, AC and/or DC power, from the PDU 204 to the uninterruptible power supply 408. The uninterruptible power supply 408 is coupled to the plurality of PSUs 702, 704 and 706 through a plurality of connections 714, 716 and 718, respectively. In an embodiment, the PSUs 702, 704 and 706 are operable to convert AC and/or DC power from the uninterruptible power supply 408 to be used by a device coupled to the PSUs 702, 704 and 706. In an embodiment, the connections 714, 716 and 718 are power line connections known in the art that are operable to provide power such as, for example, AC and/or DC power, from the uninterruptible power supply 408 to the IHSs 402, 404 and 406. While the PSUs 702, 704 and 706 are illustrated as each being coupled to the uninterruptible power supply 408 though a separate connection, the PSUs 702, 704 and 706 may share a connection.

Referring now to FIGS. 3a, 7a and 7b, the method 300 for power topology determination may be applied to the power topology system 700. The method 300 begins at block 302 where power device information is communicated through a power line connection. In an embodiment, the PDU 204, the uninterruptible power supply 408, and the PSUs 702, 704 and 706 communicate with the proxy network device 708 to transmit power device information from the PDU 204, the uninterruptible power supply 408, and the PSUs 702, 704 and 706 to the proxy network device 708 through the connections 710, 712, 714, 716 and 718. In an embodiment, the power device information includes PDU FRU information, uninterruptible power supply FRU information, PSU FRU information, power consumption information, and/or a variety of other power device information known in the art. The proxy network device 708 will store the power device information and dynamically update it as the connectivity changes. In an embodiment, removal of the power link between a proxy network device 708 and the PDU 204, UPS 408, and/or a PSU 702, 704, or 706 will result in the power device information for that PDU, UPS, or PSU being removed from the proxy network device 708. Block 304 of the method 300 is then skipped.

The method 300 then proceeds to block 306 where a power topology is provided using the power device information. In an embodiment, the management engine 202 may communicate with the proxy network device 708 to access the power device information communicated from PDU 204, the uninterruptible power supply 408, and the PSUs 702, 704 and 706 in block 302 of the method 300, and may then define a link between the power distributions unit 204, the uninterruptible power supply 408, and the PSUs 702, 704 and 706. The management engine 202 may then use all of the information communicated to create a power topology display that illustrates the PDU 204, the uninterruptible power supply 408, the PSUs 702, 704 and 706, and the connections between them. For example, a power topology display 720, illustrated in FIG. 7b, illustrates the PSUs 702, 704 and 706, the uninterruptible power supply 408, and the PDU 204. In an embodiment, the power topology 720 may be displayed on a display (e.g., the display 110 described above with reference to FIG. 1), on a print out, and/or using a variety of other display methods known in the art. A plurality of connections 722, 724 and 726 represent the connection between the uninterruptible power supply 408 and the PSUs 702, 704 and 706. In the illustrated embodiment, each of the connections 722, 724 and 726 may include an indication of power consumption information such as, for example, how many volts, watts, and/or amps of power are being drawn by the 722, 724 and 726 from the uninterruptible power supply 408. A connection 728 represents the connection between the uninterruptible power supply 408 and the PDU 214. In the illustrated embodiment, the connection 728 includes an indication of power consumption information such as, for example, how many volts, watts, and/or amps of power are being drawn by the uninterruptible power supply 408 from the PDU 204. A connection 730 represents the connection between the PDU 204 and, for example, an outside power source such a conventional AC and/or DC power source. The connection 730 includes an indication of power consumption information such as, for example, how many volts, watts, and/or amps of power are being drawn by the PDU 204 from the outside power source.

Thus, a system and method are provided that allow a power topology of a system to be quickly and accurately determined by the communication of elements in the system through the power lines which connect them. The system and method provide information within the power topology that enable an administrator of the system to, for example, plan and optimize the power infrastructure, make connectivity decisions, and determine extra power capacity.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A power topology determination system, comprising:
a management engine;
a power line communication device coupled to the management engine; and
a first power device coupled to the power line communication device through a power line connection, wherein the power line communication device is operable to retrieve first power device information from the first power device and the management engine is operable to provide the first power device information for power topology display.

2. The system of claim 1, wherein the power line communication device comprises a device selected from the group consisting of a power distribution unit, an uninterruptible power supply, a proxy network device, and combinations thereof.

3. The system of claim 1, wherein the first power device comprises a device selected from the group consisting of a power supply unit, an uninterruptible power supply, a power distribution unit, and combinations thereof.

4. The system of claim 1, wherein the management engine is coupled to the power line communication device through a management bus connection.

5. The system of claim 1, wherein the management engine is coupled to the first power device through a management bus connection.

6. The system of claim 1, wherein the first power device information includes power consumption information.

7. The system of claim 1, further comprising:
a second power device coupled to the first power device through a power line connection, wherein the power line communication device is operable to retrieve second power device information from the second power device and the management engine is operable to provide the second power device information for power topology display.

8. The system of claim 7, further comprising:
a third power device coupled to the second power device through a power line connection, wherein the power line communication device is operable to retrieve third power device information from the third power device and the management engine is operable to provide the third power device information for power topology display

9. An information handling system (IHS), comprising:
a management IHS comprising a management engine;
a power line communication device coupled to the management engine; and
a first IHS comprising a first IHS power device coupled to the power line communication device through a power line connection, wherein the power line communication device is operable to retrieve first IHS power device information from the first IHS power device and the management engine is operable to provide the first IHS power device information for power topology display.

10. The system of claim 9, wherein the power line communication device comprises a device selected from the group consisting of a power distribution unit, an uninterruptible power supply, a proxy network device, and combinations thereof.

11. The system of claim 9, wherein the first IHS power device comprises a power supply unit.

12. The system of claim 9, further comprising:
an intermediate power device coupled between the power line communication device and the first IHS power device, wherein the power line communication device is operable to retrieve intermediate power device information from the intermediate power device and the management engine is operable to provide the intermediate power device information for power topology display.

13. The system of claim 9, wherein the management engine is coupled to the power line communication device through a management bus connection.

14. The system of claim 9, wherein the management engine is coupled to the first IHS power device through a management bus connection.

15. The system of claim 9, wherein the first IHS power device information includes power consumption information.

16. The system of claim 9, further comprising:
a second IHS comprising a second IHS power device coupled to the power line communication device through a power line, wherein the power line communication device is operable to retrieve second IHS power device information from the second IHS power device and the management engine is operable to provide the second IHS power device information for power topology display.

17. A method for power topology determination, comprising:
communicating first power device information from a first power device to a power line communication device through a first power line connection;
communicating second power device information from a second power device to the power line communication device through a second power line connection; and
providing a power topology using the first power device information and the second power device information.

18. The method of claim 17, wherein the power topology comprises power consumption information.

19. The method of claim 17, further comprising:
indicating that extra power capacity exists using the power topology.

20. The method of claim 17, further comprising:
communicating with the power line communication device through a management bus connection; and
communication with the first power device and the second power device through a management bus connection.
